(19) United States
(12) Patent Application Publication
(10) Pub. No.: US 2011/0182495 A1
(43) Pub. Date: Jul. 28, 2011

(54) SYSTEM AND METHOD FOR AUTOMATIC DEFECT RECOGNITION OF AN INSPECTION IMAGE

(75) Inventors: Zhaohui Sun, Niskayuna, NY (US); Robert August Kaucic, Niskayuna, NY (US); Paulo Ricardo dos Santos Mendonça, Clifton Park, NY (US); Fei Zhao, Schenectady, NY (US)

(73) Assignee: GENERAL ELECTRIC COMPANY, Schenectady, NY (US)

(21) Appl. No.: 12/693,474

(22) Filed: Jan. 26, 2010

(51) Int. Cl. G06K 9/00

(52) U.S. Cl. 382/141

(57) ABSTRACT

A method for an anomaly detection method is provided. The method includes acquiring at least one two-dimensional or three-dimensional or n-dimensional inspection test image data of a scanned object. The method further includes partitioning the inspection test image data of the scanned object into multiple sub-regions. The method also includes computing one or more texture metrics for each sub-region. Finally, the method includes discriminating between an anomalous and a non-anomalous region in the scanned object according to one or more values of the computed texture metrics and identifying one or more anomalies in the inspection test image data.

### BACKGROUND

The invention relates generally to nondestructive testing (NDT) of manufactured parts and more particularly to a method and system for automatically identifying defects in NDT image data corresponding to a scanned object.

Generally, NDT techniques are employed for detection of defects in manufacturing parts. Such NDT techniques include producing relevant data for an object by collecting energy emitted by or transmitted through the object, such as by penetrating radiation (gamma rays, X-rays, neutrons, charged particles, etc.) sound waves, or light (infrared, ultraviolet, visible, etc.). The manner by which energy is transmitted through or emitted by any object depends upon variations in object thickness, density, and chemical composition. The energy emergent from the object is collected by appropriate detectors to form an image or object map, which image may then be realized on an image detection medium, such as a radiation sensitive detector. The detector may comprise an array of elements that record the incident energy at each element position, and map the recording onto a multi-dimensional image. The multi-dimensional image is then fed to a computer workstation and interpreted by trained personnel. Non-limiting examples of NDT modalities include X-ray, CT, infrared, eddy current, ultrasound and optical.

Automatic defect recognition (ADR) is an important component of the NDT techniques in the detection, classification or assessment of significant flaws or irregularities in manufacturing parts or objects of interest. Example of significant flaws in manufactured parts includes a defect size, shape, composition or other relevant characteristic that falls outside of the range of acceptable variability for a given structure or object of interest. Conventional ADR methods and systems have been unable to address the difficulty in discriminating between an acceptable structural variability and an unacceptable structural variability of the manufactured part, wherein the unacceptable structural variability characterizes the true defects of the manufactured part or the object of interest. Typically, a common approach to address the difficulty is by using reference-based methods. The reference-based methods include the use of an atlas, which atlas is a labeled model of the manufactured part to be inspected. The atlas indicates regions of large variability, which large variability is to be accepted due to variations in the design. However, the reference-based methods have two major difficulties. First, the reference-based method requires registration of the atlas against the manufactured part under inspection, followed by mapping between coordinate systems for describing the spatial location of points in the atlas and the inspected manufactured part or the object of interest. This method is often a computationally expensive operation. Second, the reference-based methods include treating the large variability regions liberally that may result in true defects being missed.

Accordingly, there exists a need for a reference-free alternative approach for efficient image-based automatic defect recognition for identifying an anomalous region of the NDT inspection image data corresponding to a scanned object.

### BRIEF DESCRIPTION

In accordance with an embodiment of the invention, an anomaly detection method is provided. The method includes acquiring at least one two-dimensional or three-dimensional or n-dimensional inspection test image data of a scanned object. The method further includes partitioning the inspection test image data of the scanned object into multiple sub-regions. The method also includes computing one or more texture metrics for each sub-region. Finally, the method includes discriminating between an anomalous and a non-anomalous region in the scanned object according to one or more values of the computed texture metrics and identifying one or more anomalies in the inspection test image data.

In accordance with another embodiment of the invention, an anomaly detection method is provided. The method includes acquiring at least one two-dimensional or three-dimensional or n-dimensional inspection test image data of a scanned object. The method further includes partitioning the inspection test image data of the scanned object into multiple sub-regions. The method also includes analyzing a self-similarity consistency across multiple scales for each sub-region and determining a deviation value. The method further includes comparing the deviation value with a threshold value and identifying one or more anomalies in the inspection test image data.

In accordance with yet another embodiment of the invention, an anomaly detection method is provided. The method includes acquiring at least one two-dimensional or three-dimensional or n-dimensional inspection test image data of a scanned object. The method further includes partitioning the inspection test image data of the scanned object into multiple sub-regions. The method includes computing one or more texture metrics derived from a reconstruction from one or more wavelet maxima for each sub-region for discriminating between an anomalous and a non-anomalous region in the scanned object. Finally, the method includes identifying one or more anomalies in the inspection test image data.

In accordance with yet another embodiment of the invention, an anomaly detection method is provided. The method includes acquiring at least one two-dimensional or three-dimensional or n-dimensional inspection test image data of a scanned object. The method includes registering the inspection test image data to a defect free reference image or a CAD model. The method further includes partitioning the inspection test image data of the scanned object into multiple sub-regions. The method includes computing one or more minkowski functionals for each sub-region for discriminating between an anomalous and a non-anomalous region in the scanned object. The method also includes generating a statistical reference model based on computed minkowski functionals of one or more defect-free reference images. The method further includes determining a deviation value based on the computed minkowski functionals of the inspection image data. The method also includes comparing the deviation value with a threshold value, wherein the threshold value is determined from the statistical reference model; and identifying one or more defects in the inspection test image data.

In accordance with yet another embodiment, an anomaly detection system is provided. The system includes an imaging system configured to acquire inspection test image data corresponding to a scanned object. The system also includes a computer system configured to be in signal communication with the imaging system. The computer system further includes a memory configured to store the inspection test image data corresponding to the scanned object, wherein the image data comprises at least one of an inspection test image of the scanned object and one or more reference images for a defect-free object. The computer system also includes a processor configured to process the inspection test image data corresponding to the object. The processor is further configured to receive the inspection test image data of the scanned object from the imaging system, partition the inspection test image data of the scanned object into multiple sub-regions, compute one or more texture metrics for each sub-region for discriminating between anomalous and non-anomalous region in the scanned object, generating a deviation value, compare the deviation value or median or mean value with a threshold value and identify one or more defects in the inspection test image data. Finally, the computer system comprises a display device configured to display the one or more defects in the inspection test image data corresponding to the scanned object.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of an exemplary inspection system for automatic defect recognition of an object of interest.

FIG. 2 is a flowchart illustrating an exemplary process for anomaly detection in accordance with an embodiment of the present invention.

FIG. 3 is a computation scheme of a two-dimensional test image for anomaly detection in accordance with an embodiment of the present invention.

FIG. 4 is a computation scheme of a three-dimensional test image for anomaly detection in accordance with an embodiment of the present invention.

FIG. 5 is a flowchart illustrating an exemplary process for anomaly detection in accordance with another embodiment of the present invention.

FIG. 6 is a flowchart for the application of texture metrics derived from reconstruction of wavelet maxima to automatic defect recognition.

FIG. 7 is a flowchart illustrating an exemplary process for anomaly detection in accordance with yet another embodiment of the present invention.

FIG. 8 is a flowchart for a method of application of minkowski functionals to automatic defect recognition of the present invention.

### DETAILED DESCRIPTION

As discussed in detail below, embodiments of the invention are directed towards an automated anomaly detection technique. As used herein, the phrase ‘anomalous’ refers to defects in a manufactured part having a structure that is irregular, jagged or chaotic pattern. The phrase ‘self-similarity’ refers to randomness built in natural objects having irregular, jagged or chaotic pattern across different scales. Further, the phrase ‘non-anomalous region’ refers to an artificial and man-made structure having a regular, smooth or repeatable pattern in a manufactured part or object of interest. The present invention addresses a system and methods of providing an automatic defect recognition technique, possibly in conjunction with computer assisted detection and/or diagnosis (CAD) algorithms. Such analysis may be useful in a variety of imaging contexts, such as industrial inspection system, nondestructive testing and others.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

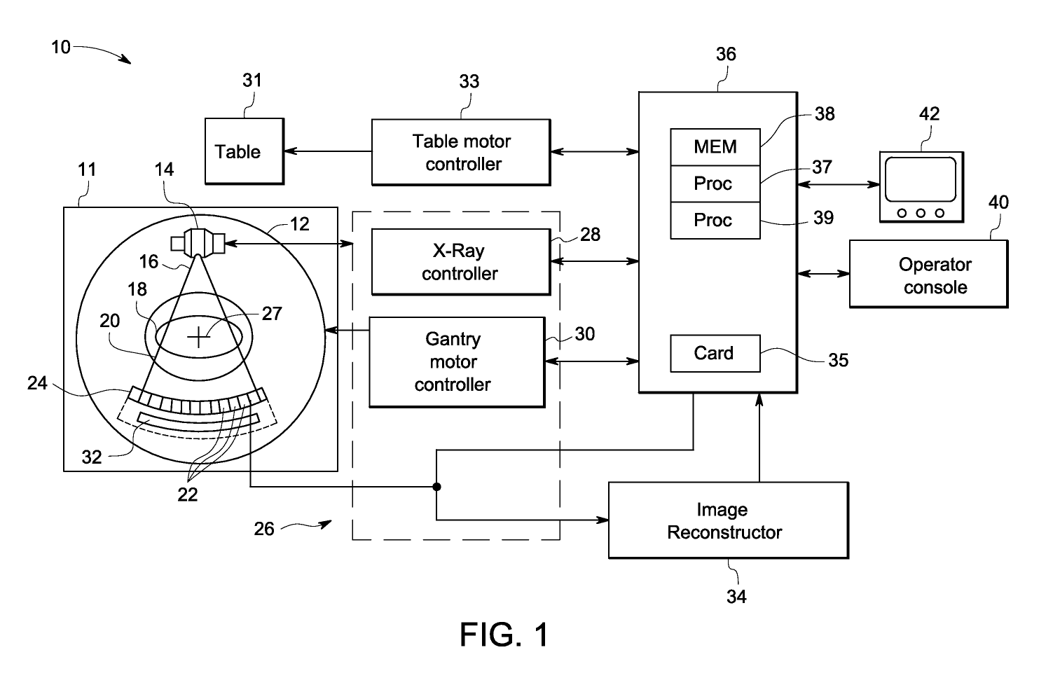

FIG. 1 is an illustration of an exemplary inspection system for processing an inspection test image data corresponding to a scanned object. It should be noted that although the illustrated example is directed to automated anomaly detection using computed tomography (CT) system, the present invention is equally applicable to other inspection modalities, non-limiting examples of which include x-ray, infrared, eddy current, ultrasound and optical. Referring to FIG. 1, the inspection system 10 includes an imaging system 11, which imaging system 11 includes a gantry 12 having an X-ray source 14 configured to emit an X-ray beam 16 responsive to electrons impinging upon a target material. In an example, the X-ray source 14 is an X-ray tube. The X-ray beam is incident upon an object 18 resulting in a transmitted X-ray beam 20 through the object 18. Non-limiting examples of the object 18 include industrial manufactured parts. The transmitted X-ray beam 20 through the object 18 is further incident upon a detector 24. In one embodiment, the detector 24 includes one or more rows or columns of detector elements 22 that produce electrical signals that represent the intensity of the transmitted beam 20. The electrical signals are acquired and processed to reconstruct an image of the features within the object 18. In a particular embodiment, the detector 24 includes a photon counting detector. In another embodiment, the detector 24 includes, a dual-layered detector or energy-integrating detector.

Rotation of the gantry 12 around a center of rotation 27 and the operation of x-ray source 14 are governed by a control system 26. The control system 26 includes an x-ray controller 28 that provides power and timing signals to the X-ray source 14, a gantry motor controller 30 that controls the rotational speed and position of the gantry 12, and a table motor controller 33 that controls motion of a table 31. An image reconstructor 34 receives sampled and digitized x-ray data from a data acquisition system 32 and performs high-speed reconstruction. The image reconstructor 34 may be part of the computed tomography system 10, or may be a remote system. Further, the reconstructed image is applied as an input to a computer system 36. The computer system 36 is adapted to be in signal communication with the imaging system 11 and stores the image in a mass storage device 38.

The mass storage device 38 is a memory that is configured to store the X-ray inspection test image data corresponding to the object 18. Further, the memory may include, but is not limited to, any type and number of memory chip, magnetic storage disks, optical storage disks, mass storage devices, or any other storage device suitable for retaining information. The computer system 36 also includes a detector interface card 35 and one or more processors 37, 39 configured to process the X-ray inspection test image data corresponding to the object 18.

It should be noted that embodiments of the invention are not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

In one embodiment, and as will be described in greater detail below, the processors 37, 39 are configured to receive the inspection test image data of the object 18 from the imaging system 11, partition the inspection test image data of the object 18 into multiple sub-regions, compute one or more texture metrics for each sub-region for discriminating between anomalous and non-anomalous regions in the scanned object, generate a deviation value, compare the deviation value with a threshold value and identify one or more defects in the inspection test image data.

In one embodiment, the computer system 36 also receives commands and scanning parameters from an operator via a console 40, which console has some form of operator interface, such as a keyboard, mouse, voice activated controller, or any other suitable input apparatus. Non-limiting examples of input apparatus include a pointing device, a touch sensitive screen device, a tablet, a read/write drive for a magnetic disk, a read/write drive for an optical disk, a read/write drive for any other input medium, an input port for a communication link (electrical or optical), a wireless receiver. An associated display device 42 allows the operator to observe the reconstructed image and other data from the computer system 36. The display device 42 may be a CRT (cathode ray tube) screen or any other suitable display device for displaying text, graphics and a graphical user interface, for example. In one embodiment, the display device 42 is configured to display one or more defects in the X-ray inspection test image corresponding to the object 18. The console 40 and the display device 42 operate in combination to provide a graphical user interface, which graphical user interface enables a user or operator to configure and operate the radiographic inspection system 10. The detector interface card 35 provides low-level control over the image detector, buffers data read out from the detector 24, and optionally reorders image pixels to convert from read-out order to display order. The operator supplied commands and parameters are used by the computer 36 to provide control signals and information to the data acquisition system 32, the X-ray controller 28, the gantry motor controller 30, and table motor controller 33.

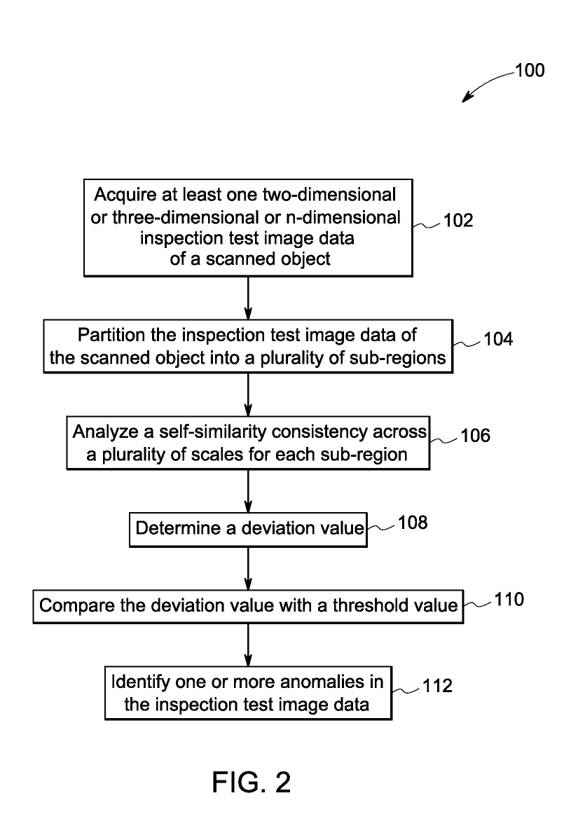

FIG. 2 illustrates a flowchart of an exemplary process 100 for anomaly detection of a scanned object in accordance with an embodiment of the present invention. For certain applications, the defects may include, but are not limited to, casting and/or manufacturing defects present in a scanned object. Further, in certain applications, the scanned object may include industrial parts, such as, for example; turbine engine components, rotors, cylinder heads and pipes. The scanned object may also include, automotive parts such as, casting wheels, engine components, and shafts. Other non-limiting exemplary applications of the present anomaly detection process 100 may be in the manufacture of aircraft engine parts. During manufacturing of aircraft engine parts, variations are inevitable due to slight variations in the casting and processing steps. Such variations or anomalies are efficiently captured by the techniques of the present invention, which are described in one or more specific embodiments below. Referring to FIG. 2, the process 100 includes acquiring at least one inspection test image data of a scanned object at step 102. In one embodiment, the inspection test image data may be at least one two-dimensional, three-dimensional or n-dimensional inspection test image data. The ‘n-dimensional’ inspection test image data signifies three or more dimensional image data acquired from scanning machines. Non-limiting examples of scanning machines include a CT machine, a X-ray machine, an ultrasound machine, an optical machine or an eddy current inspection system. In step 104, the inspection test image data of the scanned object is partitioned into multiple sub-regions. The partitioning of the inspection test image data includes segmenting the image data into multiple sub-regions. Further, in step 106, each sub-region of the inspection test image data is analyzed using a self-similarity consistency across multiple scales of the inspection test image data. An anomalous region represents defects such as cavities, spikes or porous region and have irregular patterns and possess self-similarity across multiple scales. The anomalous region within the sub-region is effectively analyzed by measuring a fractal dimension D. The fractal dimension D is a statistical quantity defined as the following equation:

$$D = {lim}_{∈ -> 0} \frac{log N ( ∈ )}{log ( 1 / ∈ ) } \qquad ( 1 )$$

The quantity N(ε) represents the number of boxes with side length ε of the sub-region under analysis. The computation of D includes counting the number of boxes N(ε) needed to cover the sub-region. Further, the computation includes reducing the image resolution by an optimum factor and recounting the number of boxes. The pair of measurements (ε,N(ε)) is calculated at each scale level for the sub-region. This corresponds to a single point observation on a log-log plot. The estimated slope of the linear regression is the computed fractal dimension D. The fractal dimension D is computed across all scales as a feature vector for substantially discriminating between an anomalous and non-anomalous region. The fractal dimension includes a feature and surface extraction of the image data and uses a self-similarity feature model involving the box counting technique. Thus, the feature and surface extraction method include estimating the fractal dimension and computing multiple feature vectors. In step 108, the method includes determining a deviation value. The deviation value is a standard deviation of the feature vectors to be used as a discriminative feature. At step 110, the determined deviation value is compared with a pre-specified threshold value. The threshold value is chosen by a receiver operating characteristic (ROC) analysis. The ROC analysis is carried out to benchmark the method steps of the embodiment of the present invention. Finally, at step 112, the sub-regions exceeding the pre-specified threshold are identified as potential anomalies in the inspection test image data.

In one embodiment, the method of computation of the fractal dimension D or box counting further includes a recursive computing of 1-D line integral Jₗᵢₙₑ, 2-D slice integral J_{slice} and 3-D integral J, for the sub-region of the inspection test image data, wherein the 1-D line integral Jₗᵢₙₑ, 2-D slice integral J_{slice} and 3-D integral J are defined as follows:

$$\begin{matrix}{J}_{line} ( x , y , z ) = {\sum }_{i = 0}^{x} I ( i , y , z ) & ( 2 ) \\ {J}_{slice} ( x , y , z ) = {\sum }_{j = 0}^{y} {\sum }_{i = 0}^{x} I ( i , j , z ) & ( 3 ) \\ J ( x , y , z ) = {\sum }_{k = 1}^{z} {\sum }_{j = 0}^{y} {\sum }_{i = 0}^{x} I ( i , j , k ) & ( 4 )\end{matrix}$$

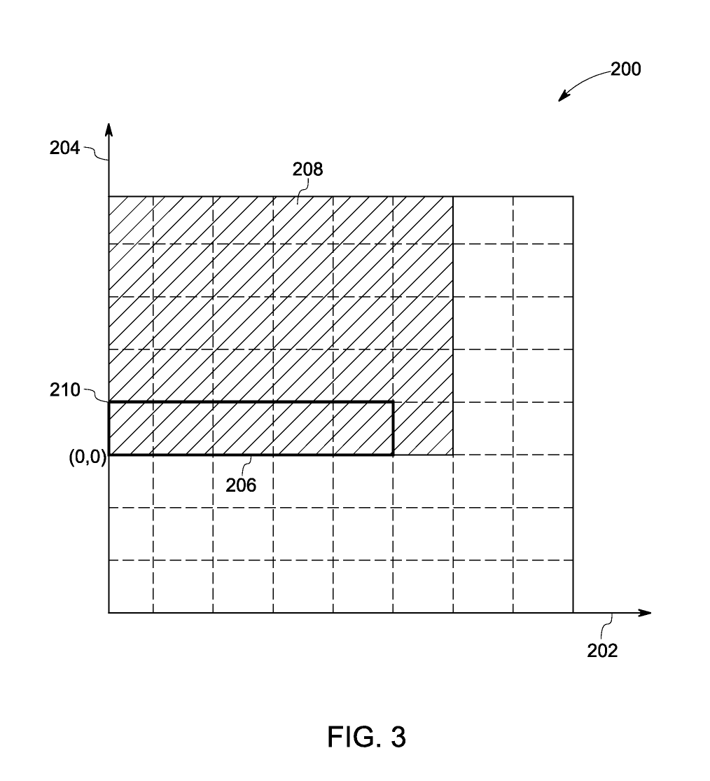

By way of an example, a computation scheme 200 of a 2-D inspection test image is shown in FIG. 3. The X-axis is represented by 202 and Y-axis is represented as 204. The line integral Jₗᵢₙₑ in equation (2) computes the integration along the X-axis 202, as the bottom line shown as 206. The accumulation is independent of the Y-axis 204 and Z-axis (not shown). The 2-D image integral J_{slice} in equation (3) is the integration of the intensity values in the rectangular region 208 bounded by the origin (0, 0) and the current pixel location (x, y) as shown in FIG. 3 on slice 210 (J_{slice}). The volume integral in equation (4) extends the same idea to 3-D, as an integration of the intensity values in a 3-D region bounded by the origin (0, 0, 0) and current voxel (x; y; z).

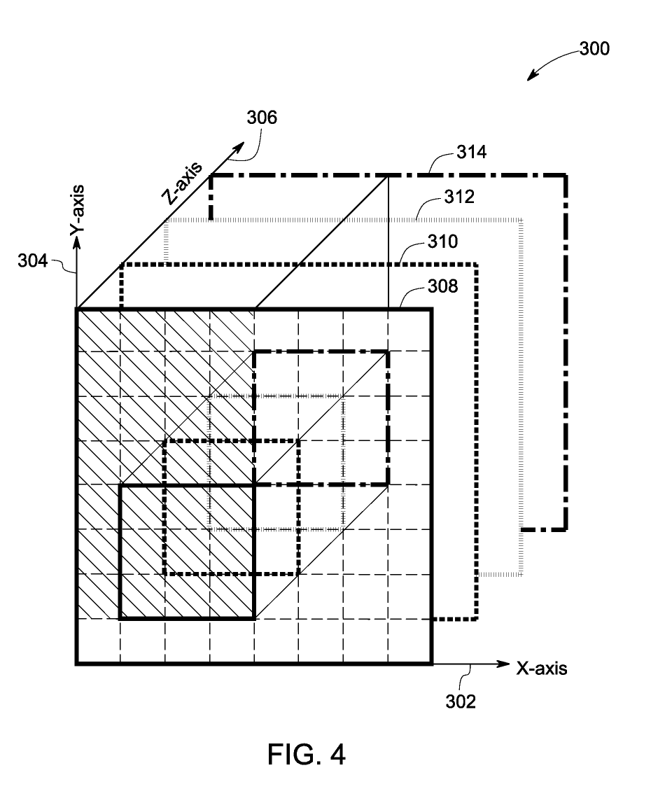

Similarly, by way of another example, a computation scheme 300 of a 3-D inspection test image is shown in FIG. 4. As shown, the X, Y and Z-axes are represented by 302, 304 and 306 respectively. The scheme 300 includes computation of a volume starting at a region 308 and sweeping across the slices 310, 312 and 314 respectively. The line, slice and volume integrals are recursively computed in a single pass and is represented by the following equations:

Jₗᵢₙₑ(x,y,z)=Jₗᵢₙₑ(x−1,y,z)+I(x,y,z) 5

J_{slice}(x,y,z)=J_{slice}(x,y−1,z)+Jₗᵢₙₑ(x,y,z) 6

J(x,y,z)=J(x,y,z−1)+J_{slice}(x,y,z) 7

In equation (5), the line integral Jₗᵢₙₑ (x; y; z) to x is the summation of previous integration Jₗᵢₙₑ (x−1; y; z) to x−1 and the current intensity value I (x; y; z). It is to be noted that the row index y and slice index z are irrelevant. In FIG. 3, the bottom 206 is the sum of the box 207 and the current pixel. The 2-D image/slice integral Lime (x; y; z) can be recursively computed from the slice integral up to the previous row J_{slice} (x; y−1; z) and the line integral Jₗᵢₙₑ (x; y; z) on the current line y. In FIG. 3, the region 210 is the sum of the box 207 and the bottom line 206. Similarly in 3-D, the volume integral J(x; y; z) can be recursively computed from the volume integral up to the previous slice J(x; y; z−1) and the current slice integration J_{slice} (x; y; z). In FIG. 4, the volume on the slices 314, 312, 310 grows to the next slice 308 by adding the slice integral 308, thereby, the 3-D volume may be efficiently computed

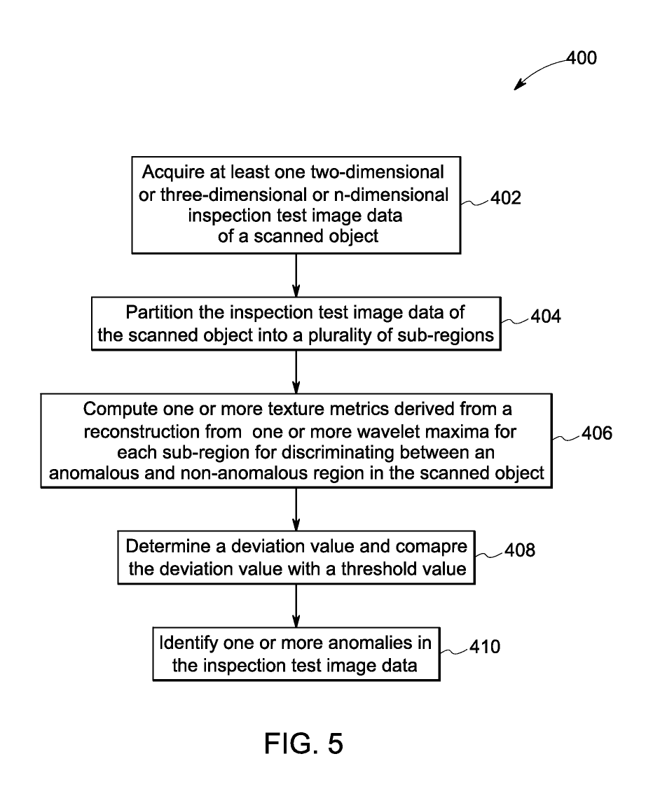

FIG. 5 illustrates a flowchart of an exemplary process 400 for anomaly detection of a scanned object in accordance with an embodiment of the present invention. The process 400 includes acquiring at least one inspection test image data of a scanned object at step 402. In one embodiment, the inspection test image data may be at least one two-dimensional, three dimensional or n-dimensional inspection test image data. The ‘n-dimensional’ inspection test image data signifies three or more dimensional image data acquired from scanning machines. Non-limiting examples of scanning machines include a CT machine, a X-ray machine, an ultrasound machine, an optical machine or an eddy current inspection system. In step 404, the inspection test image data of the scanned object is partitioned into multiple sub-regions. The partitioning of the inspection test image data includes segmenting the image data into multiple sub-regions. In one embodiment, the inspection test image is segmented into multiple overlapping sub-regions, which sub-regions may be smaller than a single pixel or voxel or as large as the image or volume. Further, in step 406, the process 400 includes computing texture metrics derived from a reconstruction from one or more wavelet maxima for each sub-region for discriminating between an anomalous region and non-anomalous region in the inspection test image data. In one embodiment, the texture metrics are derived from one or more fractals and minkowski functionals. The step 406, thus, includes computation of a wavelet decomposition for each sub-region. The wavelet decomposition or wavelet analysis is a technique to decompose a signal into multiple low and high frequency constituents. In one embodiment, the signal includes an image or a volume. The process also includes determining a deviation value and comparing the deviation value with a threshold value in step 408. Finally, in step 410, one or more anomalies are identified in the inspection test image data.

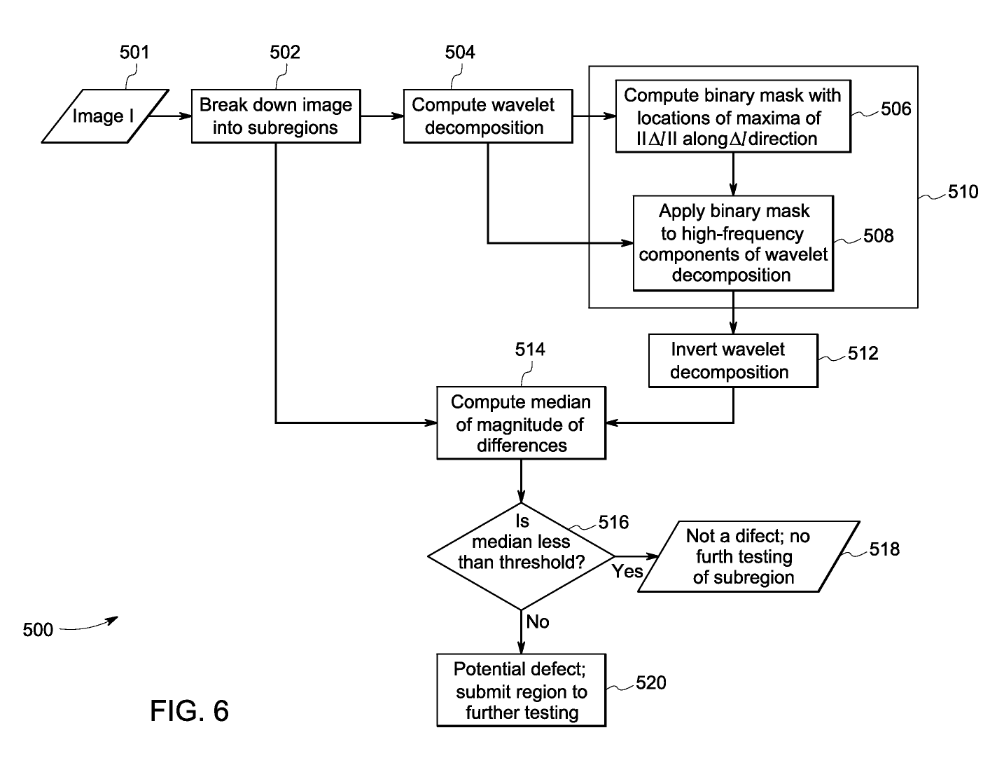

FIG. 6 shows a flowchart 500 for the application of reconstruction from wavelet maxima to automatic defect recognition. The flowchart 500 depicts a process for discriminating anomalous and non-anomalous region in an inspection test image data. The process includes acquiring at least one three-dimensional inspection test image data of a scanned object at step 501. In step 502, the inspection test image data is partitioned into multiple sub-regions. The partitioning of the inspection test image data includes segmenting the image data into multiple sub-regions. In one embodiment, the inspection test image is segmented into multiple overlapping sub-regions, which sub-regions may be smaller than a single pixel or voxel or as large as the image or volume. Further, in step 504, the process includes computing a wavelet decomposition for each sub-region. Wavelets are a family D of functions ψ_{u,s}, derived from a “mother” wavelet or function ψ via operations of translation and scaling. The wavelets are represented as follows:

$$\text{?} = \{ \text{?} = \frac{1}{\sqrt{\text{?}}} \text{?} ( \text{?} ) , \text{?} \text{?} \text{?} \text{?} \}$$

$$\text{?} \text{indicates text missing or illegible when filed}$$

A wavelet transform [W_{ψ}f](a,b) of a given square integrable function f (i.e., fεL²) is an integral transform defined by a continuous convolution operation given by the following equation:

$$[ \text{?} ] ( \text{?} ) = \frac{1}{\sqrt{\text{?}}} \text{?} \text{?} ( \text{?} ) \text{?} \text{?} . \vert \\ \text{?} \text{indicates text missing or illegible when filed}$$

A discrete wavelet transform replaces the continuous convolution above by a discrete convolution computed only at pre-specified values of shift and scale parameters. A discrete Haar wavelet uses a Haar function, which Haar function is given by the equation.

$$\text{?} = \{ \begin{matrix}1 & if 0 \leq \text{?} < 1 / 2 \\ - 1 & if 1 / 2 \leq \text{?} < 1 \\ 0 & otherwise ,\end{matrix} \vert \\ \text{?} \text{indicates text missing or illegible when filed}$$

as the mother wavelet, with scale (also known as octave) 2. The transform perfectly preserves the half of the spectrum of f corresponding to high frequencies. Therefore, due to a Nyquist-Shanon sampling theorem, the original function f can be recovered from the result of the convolution with the Haar wavelet with scale 2 and a sub sampled copy of f by a factor of 2. This operation can be recursively repeated on each sub-sampled component of the previous step; each step in the recursion is itself referred to as an octave.

The wavelet decomposition is a technique to decompose a signal into multiple low and high frequency components. In one embodiment, the signal includes an image or a volume. In step 506, the process includes computing a binary mask of local maxima with a magnitude of gradient in the local gradient direction. In step 508, the binary mask is applied to the high frequency components of the wavelet decomposition. The steps 506 and 508 are repeated for each octave at step 510. Thus, a non-maximal suppression is applied to the high-frequency components of the image or volume at each octave of the wavelet decomposition. The non-maximal suppression includes erasing of non-maxima along the local gradient direction. Further, in step 512, the process includes inverting the wavelet decomposition, implying reconstruction of the image from the wavelet maxima. Advantageously, the present invention identifies the region of the inspection test image data signifying an artificial structure including high frequency components, which high frequency components are localized and wavelet reconstruction is carried out to form the overall shape of original inspection test image data. The present invention also identifies the high-frequency components of natural structures as spatially distributed and therefore, wavelet reconstruction from localized wavelet maxima is unable to recover the original inspection test image data. In step 514, the process includes computing a deviation value. The deviation value is determined based on the differences of the sub-regions of the inspection test image data from the image formed by wavelet reconstruction. Further in step 516, the process determines whether the deviation value is less than a pre-defined threshold value. The process 500 determines a defect-free sub-region if the deviation value is less than the threshold value at step 518 and identifies potential defects in a sub-region if the deviation is more than the threshold value in step 520. The process steps 504 to 520 are repeated for each sub-region.

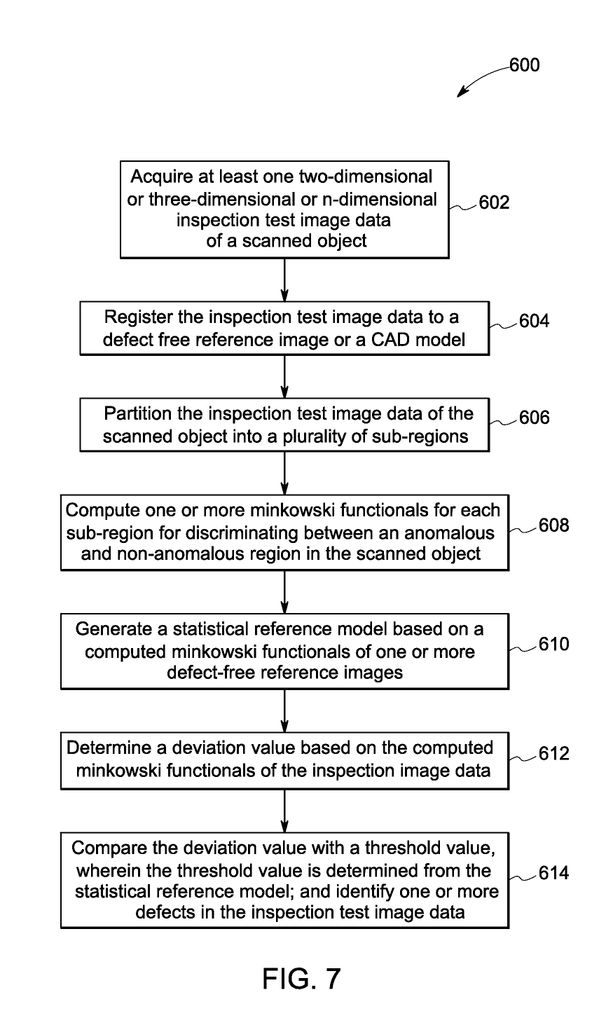

FIG. 7 illustrates a flowchart of an exemplary process 600 for anomaly detection of a scanned object in accordance with yet another embodiment of the present invention. In step 602, the process 600 includes acquiring at least one two-dimensional or three-dimensional or n-dimensional inspection test image data of a scanned object. Further, the process 600 includes registering the inspection test image data to a defect free reference image or a CAD model in step 604. In step 606, the process step includes partitioning the inspection test image data of the scanned object into multiple sub-regions. In step 608, the process includes computing one or more minkowski functionals for each sub-region for discriminating between an anomalous and non-anomalous region in the scanned object. Minkowski functionals refer to standard geometric parameters such as volume, area, length and the Euler-Poincare characteristics for a 2D and a 3D binary image. Minkowski functionals provide a basis for a set of texture metrics, which texture metrics are characterized as a continuous rigid-motion invariant valuation. Computations of the minkowski functionals are carried out through a Hadwiger's formula, which Hadwiger's formula states that any continuous rigid motion invariant valuation on Topology T can be expressed as a linear combination of minkowski functionals. In step 610, the process 600 includes generating a statistical reference model based on computed minkowski functionals of one or more defect-free reference images. Further, the process 600 includes determining a deviation value based on the computed minkowski functionals of the inspection image data in step 612. Finally, the process 600 also includes comparing the deviation value with a threshold value, wherein the threshold value is determined from the statistical reference model; and identifying one or more defects in the inspection test image data at step 614.

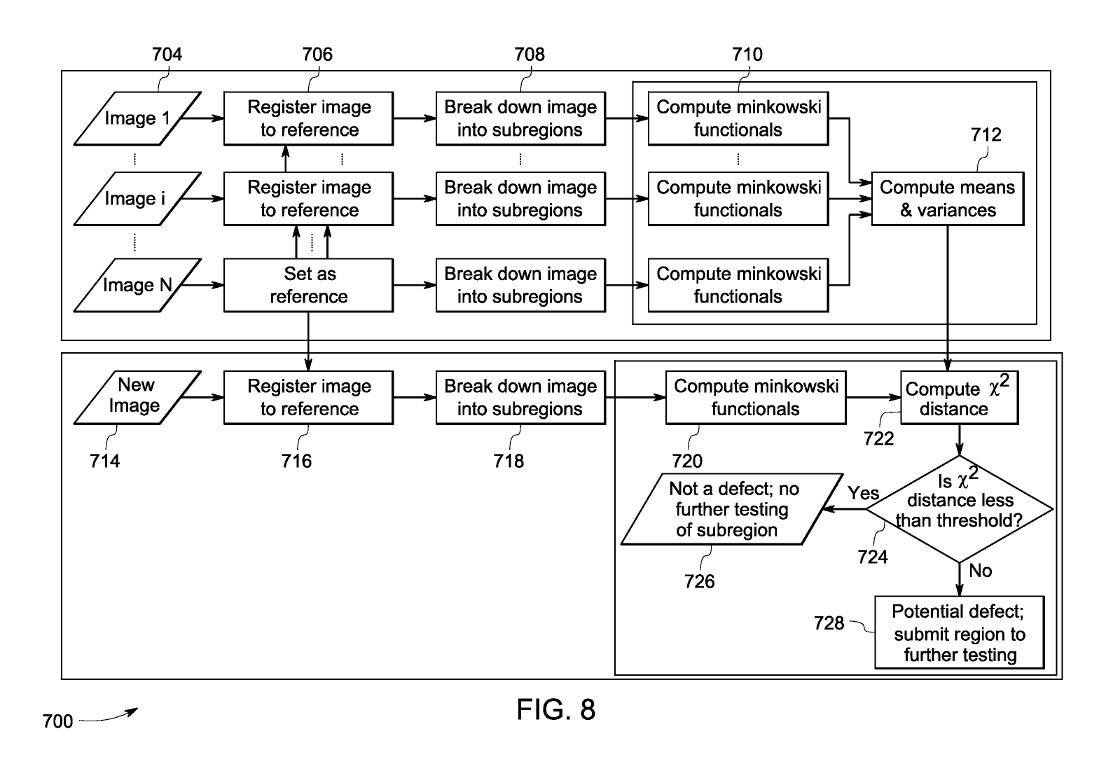

FIG. 8 shows a flowchart of a method 700 for application of minkowski functionals to automatic defect recognition of the present invention. The method 700 includes generating a statistical reference model 702 based on computation of multiple minkowski functionals. The statistical reference model 702 is generated using a set of multiple defect-free images 704 shown as image I to image N forming a training set. Further, each of the defect-free images is registered or aligned to an arbitrarily selected image reference in the training set as shown in method step 706. Each of the registered defect-free images are broken down into multiple sub-regions in step 708. In one embodiment, the sub-regions are overlapping image regions. Further, the method 700 includes computing the minkowski functionals for each sub-region in step 710 and generating the statistical reference model 702 by employing the computed minkowski functionals, which minkowski functionals are used as input data in the estimation of maximum likelihood estimators of parameters of a multivariate Gaussian distribution. In one embodiment, for gray-scale images, each minkowski functional is computed at each gray-scale value. The values of the minkowski functional at a given grey level are statistically dependent on values of the same minkowski functional at adjacent grey level of the sub-region. The method also includes computing means and variances and determining a probability distribution from the training set in step 712 for complete generation of the statistical reference model 702.

Furthermore, the method 700 includes repeating the above-mentioned procedure as carried out in the training set for an inspection test image data 714. In one embodiment, the inspection test image data is at least a 2D or 3D or n-D inspection test image data of a scanned object. The inspection test image data 714 is registered to a reference image from the statistical model 702 in step 716. In step 718; the inspection test image data is segmented into multiple sub-regions and thereafter, minkowski functionals are computed at step 720. Further, the method 700 includes computing a deviation value at step 722 by comparing the computed minkowski functional of the inspection test image data 714 with the probability distribution 712 of the statistical reference model 702. In the decision step 724, if the deviation value is less than a threshold value, then the sub-region of the inspection test image is determined to be defect-free and is not required for further testing in step 726. The threshold value is determined from the statistical reference model 702 and if the threshold value is less than the deviation value, then the sub-region of the inspection test image is identified as including potential defects in step 728. On identification of defect, the method steps from 720 to 724 are repeated for the particular sub-region.

Advantageously, the present technique ensures efficient discrimination between artificial region and a natural region, thus, identifying anomalous region in a scanned object. The present technique also provides for efficient computation, thus enabling the use of the technique in time-critical applications. The present technique also avoids the falsely flagged defects and captures true defects efficiently.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An anomaly detection method, comprising:
acquiring at least one two-dimensional or three-dimensional or n-dimensional inspection test image data of a scanned object;
partitioning the inspection test image data of the scanned object into a plurality of sub-regions;
computing one or more texture metrics for each sub-region;
discriminating between an anomalous and a non-anomalous region in the scanned object according to one or more values of the computed texture metrics; and
identifying one or more anomalies in the inspection test image data.

2. The method of claim 1, wherein the method comprises determining a deviation value or score.

3. The method of claim 2, wherein the method comprises comparing the deviation value with a threshold value.

4. The method of claim 1, wherein the method of identifying one or more anomalies comprises identifying the presence or absence of anomalous or non-anomalous regions in the scanned object.

5. The method of claim 1, wherein the texture metrics are functions of the image data for capturing the regularity of local patterns and allowing discrimination between artificial structures against the natural structures.

6. The method of claim 1, wherein the texture metrics are derived from a group comprising of fractal dimensions, minkowski functions and wavelets.

7. The method of claim 1, wherein acquiring of the inspection test image data is carried out by a scanning machine.

8. The method of claim 1, wherein the scanning machines comprises a MRI machine, a CT machine, an X-ray machine, an ultrasound machine, an optical machine or an eddy current inspection system.

9. The method of claim 1, wherein segmenting the inspection test image data comprises breaking down of the images into a plurality of sub-regions.

10. The method of claim 9, wherein the sub-regions are as small as a single pixel or voxel or as large as a complete image or volume.

11. An anomaly detection method, comprising:
acquiring at least one two-dimensional or three-dimensional or n-dimensional inspection test image data of a scanned object;
partitioning the inspection test image data of the scanned object into a plurality of sub-regions;
analyzing a self-similarity consistency across a plurality of scales for each sub-region;
determining a deviation value;
comparing the deviation value with a threshold value; and
identifying one or more anomalies in the inspection test image data.

12. The method of claim 11, wherein the method comprises computing a fractal dimension for each sub-region for discriminating between an anomalous and non-anomalous region in the scanned object.

13. The method of claim 12, wherein computing the fractal dimension comprises a feature and surface extraction using a self-similarity feature model involving a box counting technique.

14. The method of claim 13, wherein the method comprises a recursive computational method for computing line, region and volume integrals.

15. The method of claim 13, wherein the method of the feature and surface extraction comprises estimating the fractal dimension and computing a plurality of feature vectors.

16. The method of claim 11, wherein determining the deviation value comprises classifying the feature vectors in order to label the defected regions of the image.

17. The method of claim 11, wherein the threshold value is computed using a receiver operating characteristic technique.

18. An anomaly detection method, comprising:
acquiring at least one two-dimensional or three-dimensional or n-dimensional inspection test image data of a scanned object;
partitioning the inspection test image data of the scanned object into a plurality of sub-regions;
computing one or more texture metrics derived from a reconstruction from one or more wavelet maxima for each sub-region for discriminating between an anomalous and a non-anomalous region in the scanned object; and
identifying one or more anomalies in the inspection test image data.

19. The method of claim 18, wherein the method comprises determining a deviation value or score.

20. The method of claim 18, wherein the method comprises comparing the deviation value with a threshold value.

21. The method of claim 18, wherein the method comprises computing a binary mask for applying to a plurality of high frequency components of the wavelet decomposition

22. The method of claim 21, the method further comprises computing the binary mask of local maxima of magnitude and direction of a gradient vector in the sub-region.

23. The method of claim 18, wherein the method further comprises applying the computed wavelet decomposition to a result of high frequency components of the wavelet decomposition applied with binary mask.

24. The method of claim 18, wherein the method comprises inverting the wavelet decomposition.

25. An anomaly detection method, comprising:
acquiring at least one two-dimensional or three-dimensional or n-dimensional inspection test image data of a scanned object;
registering the inspection test image data to a defect free reference image or a CAD model;
partitioning the inspection test image data of the scanned object into a plurality of sub-regions;
computing one or more minkowski functionals for each sub-region for discriminating between an anomalous and non-anomalous region in the scanned object;
generating a statistical reference model based on computed minkowski functionals of one or more defect-free reference images;
determining a deviation value based on the computed minkowski functionals of the inspection image data;
comparing the deviation value with a threshold value, wherein the threshold value is determined from the statistical reference model; and
identifying one or more defects in the inspection test image data.

26. The method of claim 25, wherein the statistical reference model is generated using one or more defect-free images forming a training set.

27. The method of claim 25, wherein generating of the reference statistical or CAD model comprises registering of each of the defect-free image to another reference image and partitioned into a plurality of sub-regions.

28. The method of claim 25, wherein the generating of the reference statistical or CAD model comprises computing minkowski functionals of the plurality of sub-regions and determining a statistical parameter or value.

29. An anomaly detection system comprising:
an imaging system configured to acquire inspection test image data corresponding to a scanned object;
a computer system configured to be in signal communication with the imaging system, wherein the computer system comprises:
a memory configured to store the inspection test image data corresponding to the scanned object, wherein the image data comprises at least one of an inspection test image of the scanned object and one or more reference images for a defect-free object;
a processor configured to process the inspection test image data corresponding to the object, wherein the processor is further configured to:
receive the inspection test image data of the scanned object from the imaging system;
partition the inspection test image data of the scanned object into a plurality of sub-regions;
compute one or more texture metrics for each sub-region for discriminating between an anomalous and non-anomalous region in the scanned object;
generate a deviation value;
compare the deviation value with a threshold value; and
identify one or more defects in the inspection test image data; and
a display device configured to display the one or more defects in the inspection test image data corresponding to the scanned object.
